(19) United States
(12) Patent Application Publication
(10) Pub. No.: US 2007/0069841 A1
(43) Pub. Date: Mar. 29, 2007

(54) Motor and pump in which the motor is mounted

(75) Inventor: Hideki Kusano, Kyoto (JP)

Correspondence Address: JUDGE & MURAKAMI IP ASSOCIATES, DOJIMIA BUILDING, 7TH FLOOR, 6-8 NISHITEMMA 2-CHOME, KITA-KU, OSAKA-SHI, 530-0047, JP

(73) Assignee: Nidec Corporation, Kyoto (JP)

(21) Appl. No.: 11/535,583

(22) Filed: Sep. 27, 2006

(30) Foreign Application Priority Data
Sep. 27, 2005 (JP) JP-2005-279266

(51) Int. Cl. H01H 9/02

(52) U.S. Cl. 335/202

(57) ABSTRACT

In a canned motor, a second cover section for covering a surface of an armature on an opposite side of a first cover section is formed from a pressed metal plate so that the motor can be downsized and inexpensively manufactured. Further, the motor can be easily assembled in such a manner that a bottom of the second cover section and a busbar are made to abut each other so as to decide a position of the armature along a central axis J1.

### BACKGROUND OF THE INVENTION

1. Technical Field

The present invention relates to an electrically-driven motor and pump in which the motor is mounted.

2. Description of the Related Art

In a conventional electrically-driven motor used in a water pump, a plurality of resin holders having a cup shape is combined so that a space for sealing an armature or the like is formed in order to isolate the armature from liquid outside. Further, a circuit board for driving the motor is provided on an outer side of the motor in order to reduce heat generated inside the motor or avoid any influence from heat generated in the armature. As a result, a space required for providing the motor is substantively increased.

When the plurality of resin holders having the cup shape is combined so that the space for sealing the armature is formed, however, processing costs are increased. As further disadvantages, it is necessary to increase a thickness of the resin cup-shaped holders for molding and to use special heat-resistance resin when a temperature is high in a use environment, which increases material costs.

### BRIEF SUMMARY OF THE INVENTION

In a motor according to the present invention, a concave part of a second cover section for accommodating an armature by covering an outer-side surface thereof can be inexpensively manufactured in comparison to the formation of the second cover section using a resin material in such a manner that a metal plate is formed in a cylindrical shape having a bottom by means of press work. Further, an outer peripheral surface of the armature and the second cover section are in contact with each other so that heat of the armature can be released toward an outer side of the second cover section.

In the motor according to the present invention, the bottom of the second cover section and an upper surface of a busbar are made to abut each other and a lower surface of the busbar or a lower surface of a circuit board and the armature are made to abut each other so that a position of the armature along a central axis is decided. Therefore, the position of the armature along the central axis can be decided in such a simple manner that a group which includes the circuit board, the busbar and the armature are secured in advance is inserted from an opening side of the second cover section and the busbar and the bottom formed on the opposite side of the opening are thereby made to abut each other. As a result, the motor can be inexpensively manufactured.

### BRIEF DESCRIPTION OF THE SEVERAL VIEWS OF THE DRAWINGS

FIG. 1 is a schematic sectional view of an electrically-driven motor in a direction along a central axis thereof according to a preferred embodiment 1 of the present invention.

FIG. 2 is a left-side side view of the motor.

FIG. 3 is a right-side side view of the motor.

FIG. 4 is a flow chart of manufacturing steps of the motor.

FIG. 5 is a schematic illustration of a state in Step S1 in FIG. 4.

FIG. 6 is a schematic illustration of a state in Step S2 in FIG. 4.

FIG. 7 is a schematic illustration of a state in Step S3 in FIG. 4.

FIG. 8 is a schematic illustration of a state in Step S4 in FIG. 4.

FIG. 9 is a schematic sectional view of an electrically-driven motor in a direction along a central axis thereof according to a preferred embodiment 2 of the present invention.

FIG. 10 is a schematic sectional view of a pump in a direction along a central axis thereof according to an example of the preferred embodiments.

### DETAILED DESCRIPTION OF THE INVENTION

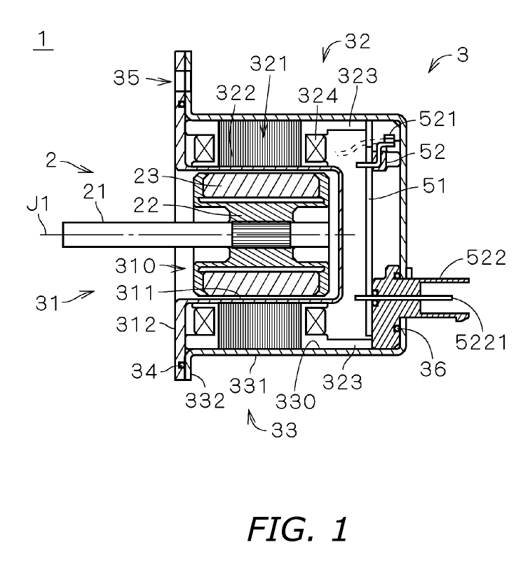

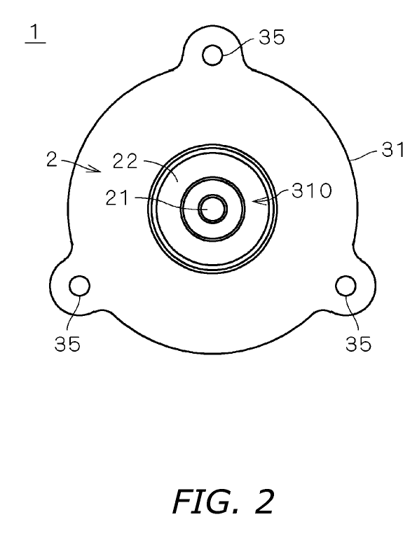

FIG. 1 is a longitudinal schematic sectional view of an electrically-driven motor 1 according to a preferred embodiment 1 of the present invention. FIG. 2 is a left-side side view of the motor 1 observed from an output side thereof.

The motor 1 comprises a stator assembly 3 provided with a recessed part 310 having an inner-side cylindrical surface for allowing inflow of liquid and a rotating body 2 which rotates in the recessed part 310 on a central axis J1 of the recessed part 310 as shown in FIG. 1. The motor 1 is a so-called canned brushless motor having such a structure that an armature is completely sealed with a partition plate interposed between the stator assembly 3 and the rotating body 2. In FIG. 1, a parallel oblique line is omitted in details of the sectional surface.

The rotating body 2 comprises a shaft 21 extending along the central axis J1, a rotor main body 22 formed in such a manner that a resin material is molded in a periphery of the shaft 21, and a field magnet 23 (shown in only FIG. 1) secured in the periphery of the shaft 21 between the shaft 21 and the inner-side surface of the recessed part 310 of the stator assembly 3 via the rotor main body 22 as shown in FIGS. 1 and 2. As shown in FIG. 1, anti-slip grooves are formed in a section joined with the rotor main body 22 of the shaft 21 so that the rotor main body 22 is prevented from rotating independently from the shaft 21.

The stator assembly 3 comprises a first cover section 31 comprising a cylindrical part 311 having a bottom (hereinafter, simply referred to as “cylindrical part”) whose inner surface constitutes the recessed part 310 and a flat plate part 312 which is a part extending substantially vertical to the central axis J1 from an opening of the recessed part 310, an armature 32 provided in a periphery of the cylindrical section 311, and a second cover section 33 for covering an outer-side surface of the armature 32 and a surface of the armature 32 opposite to the first cover section 31.

The cylindrical part 311 of the first cover section 31 has to be non-magnetic and non-conductive in order to prevent generation of eddy currents due to a magnetic force of the armature 32. In the present preferred embodiment, the first cover section 31 is formed from a resin material. The second cover section is formed in such a manner that a metal plate (for example, galvanized steel plate) is formed by means of press work. The second cover section comprises a cylindrical part 331 having a bottom as a concave part(hereinafter, simply referred to as “cylindrical part”) whose inner-side surface is larger than the recessed part of the first cover section 31, and a flange part 332 extending substantially vertical to the central axis J1 from the opening. An upper surface of the flat plate part 312 of the first cover section 31 and a lower surface of the flange part 332 of the second cover section 33 are combined with each other via an O-ring 34 which is a seal member so that a space for sealing the armature 32 is formed.

As shown in FIGS. 1 and 2, a section where the first cover section 31 and the second cover section 33 overlap with each other is provided with three mounting holes 35 which penetrate through the both sections. The motor 1 is, for example, fastened to a pump casing or the like via the mounting holes 35 and thereby used as a driving source of a water pump.

The armature 32 is in contact with an inner-side surface 330 of the cylindrical part 331 of the second cover section 33 as shown in FIG. 1. The armature 32 is provided so that a central axis thereof matches the central axis J1 of the recessed part 310. A core 321 of the armature 32 formed from a magnetic material has a plurality of teeth 322 having edges extending from an inner peripheral surface of a core back which is an annular outer peripheral part toward the central axis J1 and arranged in a radial pattern with the central axis J1 as a center of the radial pattern (in other words, extending from the inner-side surface 330 of the second cover section 33 toward the shaft 21 and the field magnet 23).

The armature 32 comprises two insulators 323 for covering the plurality of teeth 322 from both side toward the central axis J1 and a coil 324 provided in such a manner that an electric lead is wound around the plurality of teeth 322 covered with the insulators 323 in multiple layers. The coil 324 is formed in such a manner that the electric lead is wound around the teeth 322 and an outer periphery of the insulator 323 toward the central axis J1. The insulators 323 electrically insulate the core 321 of the armature 32 from the coil 324. An outer-side surface of the core 321 is pressed into the inner-side surface 330 of the second cover section 33 so that the armature 32 is secured inside the second cover section 33.

The stator assembly 3 further comprises, in the sealed space, a circuit board 51 on which electronic parts for forming a drive current supplied to the armature 32 are mounted, and a busbar 52 for leading the drive current from the circuit board 51 to the armature 32 (in FIG. 1, the sectional surface of the busbar 52 is provided with parallel oblique lines above and below on the right side of the circuit board 51).

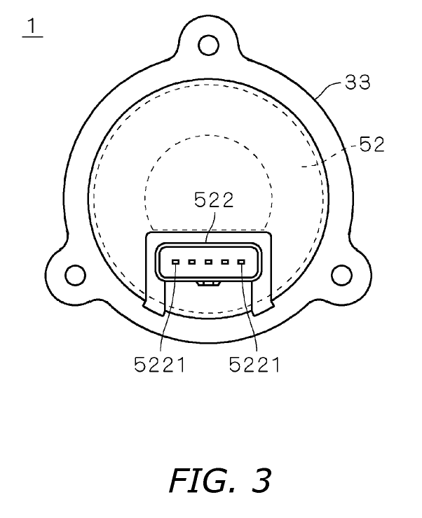

FIG. 3 is a right-side side view of the motor 1 of FIG. 1 observed from the opposite side of the output side. A substantial shape of the busbar 52 having an annular shape is shown by broken lines.

The busbar 52 is annularly formed from a resin material so that plurality of terminals 521 to which the electric lead from the coil 324 is connected by means of caulking as shown in FIG. 1 and a connector 522 to which an external wiring is connected as shown in FIGS. 1 and 3 are integral with each other. The busbar 52 is thereby electrically connected to the circuit board 51 and the armature 32.

The connector 522 has connector pins 5221. Power supplied from an external power supply, a signal having a predetermined frequency for controlling the rotation and the like are inputted to the connecter 522 from the connector pins 5221. These inputs are transmitted to the circuit board 51 via the connector 522. In the circuit board 51, drive currents having u, v and w phases are generated at a predetermined timing from the supplied power by IC (integrated circuit) which is an electronic part mounted thereon. These drive currents are supplied to the armature 32 via (transmitting through) the terminals 521 of the busbar 52. As a result, a torque centered on the central axis J1 is generated between the armature 32 and the field magnet 23, which rotates the rotating body 2 in the recessed part 310.

As shown in FIG. 1, a part of the terminals 521 of the busbar 52 and a part of each of the connector pins 5221 protrude toward the first-cover-section 31 side (that is the rotating-body-2 side). Then, the respective protruding parts are inserted into the circuit board 51 and soldered thereto, and the busbar 52 is contacted by the circuit board 51 and thereby secured. Further, the busbar 52 abuts the bottom of the second cover section 33 on the opposite side of the first cover section 31 and thereby secured. At the time, an O-ring 36, which is a seal member, is provided at a part of the connector 522 abutting the second cover section 33. The O-ring 36 can prevent inflow of liquid from outside into the second cover section 33. In FIG. 1, a part of the busbar 52 provided behind the terminals 521 in the periphery of the terminals 521 is shown in order to illustrate a state where the bottom of the second cover section 33 and the busbar 52 abut each other.

In a conventional motor for pump, a part corresponding to the first cover section 31 was formed from a resin material, in response to which, a part corresponding to the second cover section 33 was formed from a similar resin material. However, in the motor 1 according to the present invention, the metal plate is selected as the material and subjected to the press work so that the second cover section 33 is formed. As a result, productivity can be increased while material and processing costs can be reduced at the same time in comparison to the formation of the second cover section 33 from the resin material. Therefore, manufacturing costs of the motor can be reduced. Further, a thickness of the second cover section 33 can be reduced in the case where the metal plate is pressed in comparison to the resin material, which downsizes the motor. The core 321 of the armature 32 is pressed into the second cover section 33 so that the armature 32 can easily contact the second cover section 33. Because the second cover section 33 is formed from metal, heat generated in the armature 32 can be favorably released via the second cover 33.

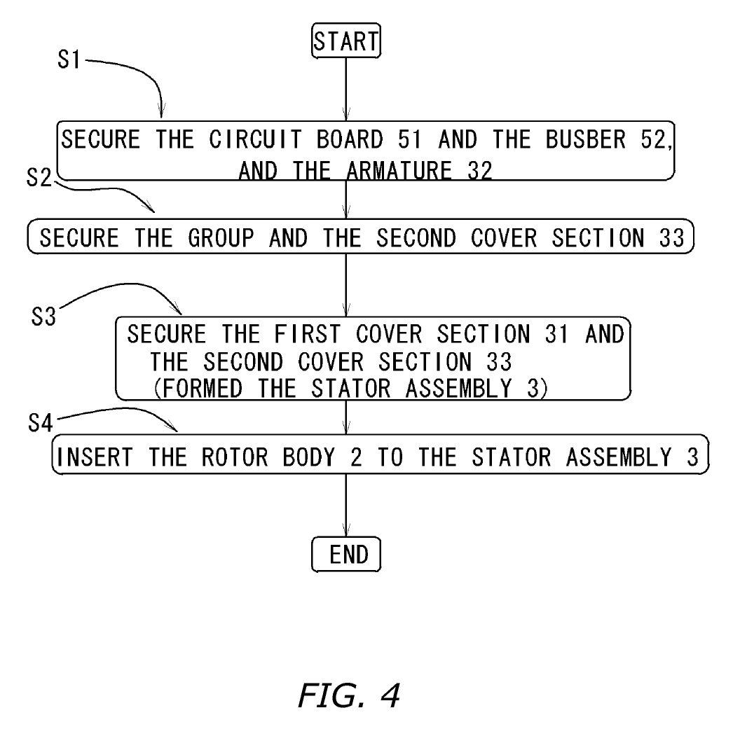

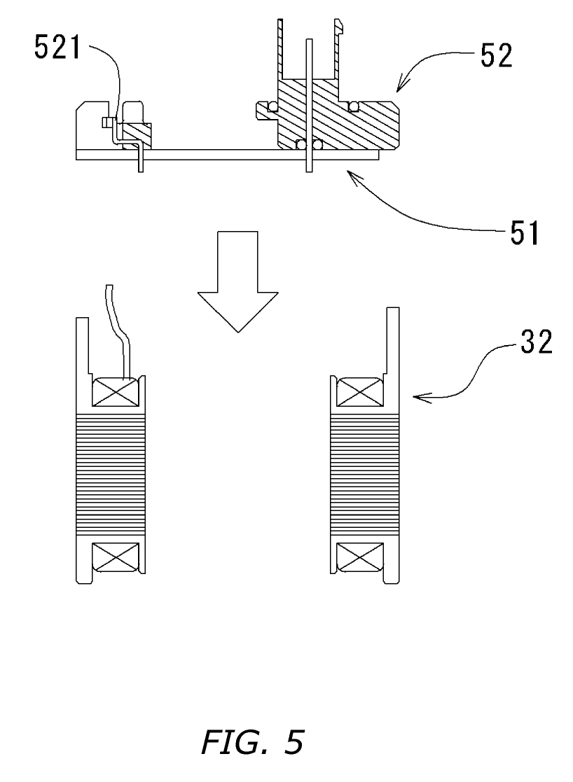

Referring to FIGS. 4 through 8, manufacturing steps of the motor 1 are described. FIG. 4 is a flow chart of the manufacturing steps of the motor 1. FIGS. 5 through 8 are schematic illustrations of states in the respective steps.

Referring to FIG. 5, first, a lower surface of the busbar 52 to which the circuit board 51 is secured and an upper surface of an insulator 323 which covered from upper side are made to abut each other. In the foregoing state, an end of the conductive lead, which is a coil end, is caulked and thereby secured to the terminals 521 of the busbar 52 (Step S1 shown in FIG. 4). The end of the conductive lead and the terminal 521 may be secured by means of soldering or welding other than caulking.

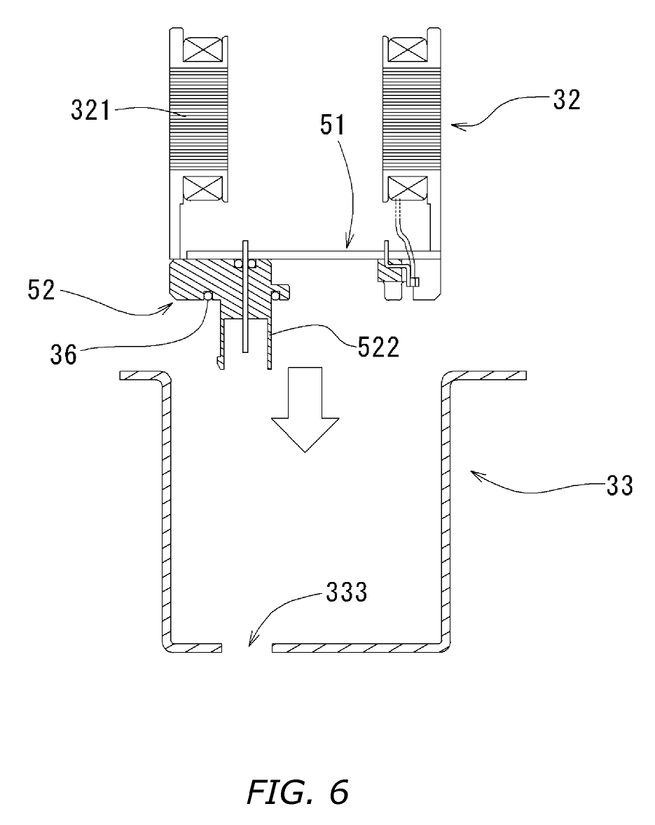

Referring to FIG. 6, the assembly comprising the armature 32, circuit board 51 and busbar 52 formed in the Step S1 is inserted from the opening side of the second cover section 33. An opening hole 333 is formed at the bottom of the second cover section 33. The busbar 52 is inserted so that the connector 522 inserts through the opening hole 333. Then, an upper surface of the busbar 52 and a lower surface at the bottom of the second cover section 33 abut each other so that a position of the busbar 52 along the central axis J1 is decided (Step S2 shown in FIG. 4). The O-ring 36 is provided on the upper surface of the connector 522 of the busbar 52 in the Step S2. When the upper surface of the busbar 52 and the lower surface at the bottom of the second cover section 33 abut each other, the O-ring 36 abuts a periphery of the opening hole 333 and is thereby crushed. As a result, an interval between the bottom of the second cover section 33 and the upper surface of the busbar 52 is embedded with the crushed O-ring 36. Therefore, the O-ring 36 prevents the liquid from outside invading into the second cover section 33 through the opening hole 333. Further, in the Step S2, the outer-peripheral surface of the core 321 of the armature 32 is pressed into the inner-side surface 330 of the second cover section 33, and a radial position of the armature 32 is thereby decided.

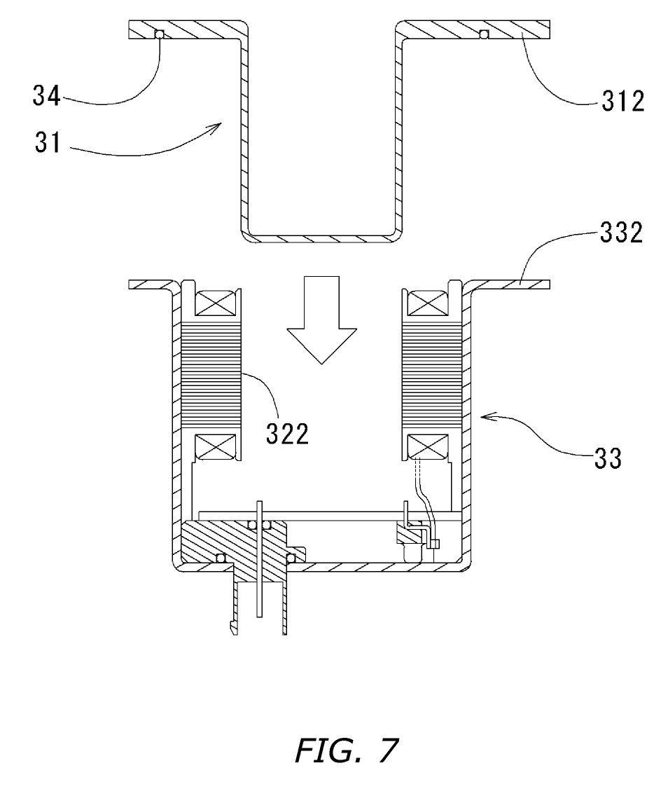

Next, referring to FIG. 7, the first cover section 31 is inserted from the opening side of the second cover section 33 so as to penetrate through the inner peripheral surface of the teeth 322 of the armature 32 (Step S3 shown in FIG. 4). The position of the first cover section 31 along the central axis J1 is determined when the lower surface of the plate section 312 of the first cover section 31 and the upper surface of the flange part 332 of the second cover section 33 abut each other. The O-ring 34 is provided in the flat plate part 312. Then, the flat plate part 312 abuts the flange part 332, and the O-ring 34 is thereby crushed, which embeds an interval between the flat plate part 312 and the flange part 332. Therefore, the O-ring 34 prevents invasion of the liquid from outside into the second cover section 33. The stator assembly 3 is formed in the Step S3.

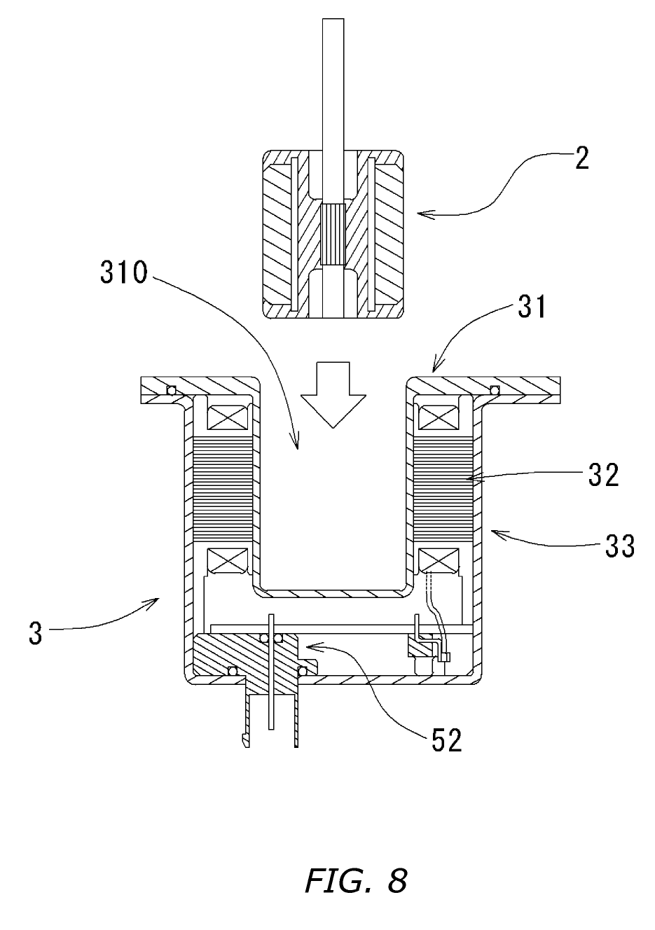

Next, referring to FIG. 8, the rotating body 2 is inserted through the inner-side surface of the first cover section 33, that is the recessed part 310 of the stator assembly 3 (Step S4 shown in FIG. 4). The motor 1 is thereby formed.

The stator assembly 3 can only be formed from one direction of the insertion on the opening side of the second cover section 33. Therefore, the assembling process can be facilitated. As a result, the productivity can be increased, while the manufacturing costs can be reduced. Further, the positions of the busbar 52 and the armature 32 where they are inserted into and abut the second cover section 33 are the positions along the central axis J1. Therefore, it is unnecessary to prepare a special jig for deciding the positions along the central axis J1 when the stator assembly 3 is produced. As a result, the stator assembly 3 can be easily manufactured.

In the motor 1, the circuit board 51 and the busbar 52 are provided very near the coil end in the sealed space of the stator assembly 3, which facilitates the wire connection to the coil 324. Further, a space for installing the motor 1 is further reduced because the circuit board 51 is incorporated. In the case where the circuit board 51 is provided closer to the flat-plate-part-31 2 side than the bottom of the first cover section 31, it is necessary to make the circuit board 51 annular in order to insert the cylindrical part 311 of the first cover section 31 into the circuit board 51, which consequently reduces an area of the circuit board 51. A disadvantage generated therefrom is a possibility that necessary electronic components cannot be mounted because a degree of freedom in designing a wiring pattern in the circuit board 51 is reduced. However, in the motor 1 according to the present invention, it is unnecessary for the circuit board 51 to be annular since the circuit board 51 is provided closer to the bottom side of the second cover section 33 than the bottom of the first cover section 31. Therefore, the area of the circuit board 51 can be sufficiently large.

Further, the busbar 52 contacts the circuit board 51 and secured thereto, and abuts the second cover section 33 formed from metal so that the heat generated in the circuit board 51 can be favorably released. As shown in FIG. 1, in the motor 1, the position of the armature 32 along the central axis J1 is determined when the insulator 323 which covered from upper side abuts the circuit board 51. In such a structure, the position of the armature 32 along the central axis J1 can be determined in such a manner that the insulator 323 which covered from upper side is made to abut the busbar 52 after the busbar 52 and the circuit board 51 are inserted so as to abut the bottom of the second cover section 33 on the opposite side of the first cover section 31.

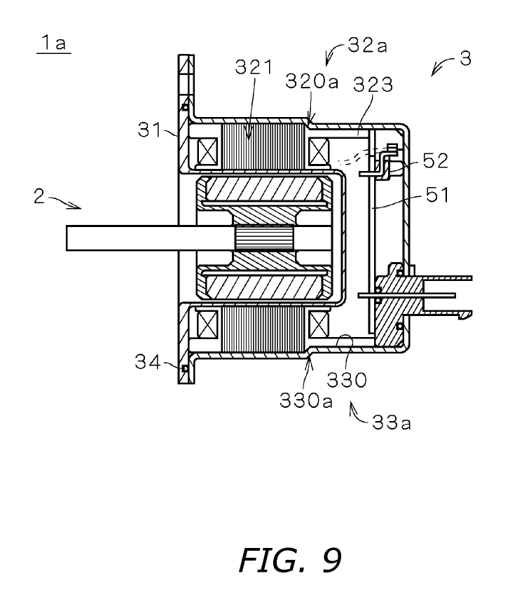

Next, referring to FIG. 9, a preferred embodiment 2 of the present invention is described. FIG. 9 is a longitudinal sectional view of an electrically-driven motor 1a according to the preferred embodiment 2. A structure of the motor 1a is similar to that of the motor 1 shown in FIG. 1 except that the armature 32 and the second cover section 33 of the stator assembly 3 in the motor 1 shown in FIG. 1 are replaced with those having different shapes. Therefore, like components other than the foregoing components are provided with the same reference symbols as shown in FIG. 1.

An armature 32a of the motor 1a comprises a step part 320a at which the core 321 protrudes outward between the core 321 and the insulators 323 in an outer peripheral surface thereof. A second cover section 33a comprises a step part 330a in which a diameter of an inner peripheral surface 330 is reduced on a bottom side thereof.

In the motor 1a, as shown in FIG. 4, when the busbar 52, circuit board 51 and armature 32a are assembled and inserted into the second cover section 33a, the step part 320a of the armature 32a (in particular, core 321) abuts the step part 330a of the second cover section 33a so that a position of the armature 32a along the central axis J1 is determined. Accordingly, in the assembly of the motor 1a, the position of the armature 32a can be easily and accurately decided in such a simple manner that the assembly including the armature 32a is inserted into the second cover section 33a. After that, the first cover section 31 provided with the O-ring 34 is secured. In this manner, such a simplified assembling process can be realized.

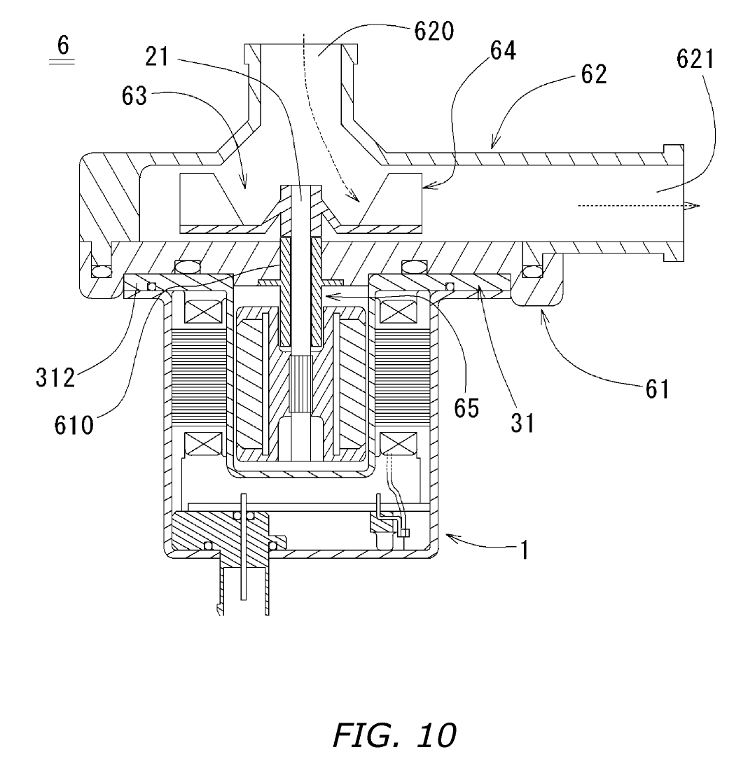

Next, referring to FIG. 10, a pump in which the motor 1 according to the present invention is installed according to an example of the preferred embodiments is described. FIG. 10 is a longitudinal sectional view of example of the pump in which the motor 1 according to the present invention is installed.

A pump 6 comprises a first pump casing 61 abutting the flat plate part 312 of the first cover section 31 and a second pump casing 62 for forming a pump chamber 63 by abutting the first pump casing 61. An impeller 64 secured to the shaft 21 and rotating integral with the rotating body 2 is provided in the pump chamber 63.

A through opening hole 610 along the central axis J1 penetrating through the shaft 21 is formed in the first pump casing 61. A bearing 65 for rotatably supporting the shaft 21 in a radial direction is secured to an inner-side peripheral surface of the opening hole 610. The bearing 65 is formed from a resin material in a substantially cylindrical shape having a through opening hole along the central axis J1 penetrating through the shaft 21.

The second pump casing 62 comprises an inflow port 620 through which liquid flows into the pump chamber 63 and an outflow port 621 through which the liquid in the pump chamber 63 flows out. The inflow port 620 is formed along the central axis J1. The outflow port 621 is formed along the radial direction.

A spiral flow path (not shown) is formed in the pump chamber 63, and the outflow port 621 is circumferentially formed along the path. When the impeller 64 is rotated, liquid in the path heads for a direction where the impeller 64 is rotated and flows along the flow path.

The motor and the pump according to the present invention is desirably installed in a vehicle. A guarantee for a high-temperature resistance is demanded in the vehicle in comparison with home electric appliances in general household. Therefore, when the second cover section 33, in particular, is formed from the resin material, a special resin material capable of dealing with a high temperature is necessary, which significantly increases the material costs of the second cover section 33. However, when the second cover section 33 is formed from the metal plate subjected to the press work, the material costs can be controlled to be low while the heat releasability of the armature 32 is guaranteed at the same time. As a result, the motor and the pump which are durable in a high-temperature environment such as vehicle can be inexpensively provided.

The preferred embodiments of the present invention were thus far described, however, the present invention is not limited to the foregoing embodiments and can be variously modified.

For example, the motors 1 and 1a according to the preferred embodiments adopt a so-called sensor-less drive in which an element for detecting a rotating position, such as a Hall element, is not used. The element for detecting the rotating position may be provided on the circuit board 51 so that the drive of the motor is thereby controlled.

In the foregoing preferred embodiment, the first cover section 31 is formed from the resin material, however, the first cover section 31 may be formed from a non-conductive material or a non-magnetic material. Further, the first cover section 31 may be formed from a plurality of combined members, in which case the second cover sections 33 and 33a may be formed from a metal plate other than the galvanized steel plate.

The first cover section 31 is provided with the flat plate part 312 on the opening side of the cylindrical part 311. The flat plate part 312 may have various shapes as far as it is provided as the part extending substantially vertical to the central axis J1. The flange part 332 of the second cover section 33 may also have various shapes depending on the first cover section 31.

The seal member provided between the first cover section 31 and the second cover section 33 may not be the O-ring 34, and an adhesive or curing resin may be used as the seal member.

The upper surface of the insulator 323 of the armature 32 abuts the lower surface of the busbar 52, however, the upper surface may abut the lower surface of the circuit board 51 in order to decide the position of the armature 32 along the central axis J1.

In the motor 1a according to the second preferred embodiment, the diameter of the second cover section 33 is reduced on the bottom side so that the step part 330a is formed. The step part 330a may be provided in any other manner as far as it protrudes inward from the inner-side surface 330. For example, a part of the inner-side surface 330 of the cylindrical part 331 may be deformed so that a plurality of protrusions protruding inward is circumferentially arranged as the step part, and the position of the armature 32 along the central axis J1 may be decided by the step part 320a of the armature 32 abutting the plurality of protrusions. The strength of the second cover section 33 can be improved so that the step part 330a is formed. The point of view, it is desirable that the step part 330a formed circular shape.

What is claimed is:

1. An electrically-driven motor comprising:
a first cover section, being watertight, including a recessed part having a cylindrical shape closed at one end thereof, and a flat plate part extending toward a radially outward direction from a rim of an opening of the recessed part;
an armature having plural teeth arranged around the recessed part of the first cover section, each tip of the teeth directing toward a radially inward direction;
a shaft extending along the central axis of the recessed part of the first cover section, an one end thereof accommodated in the recessed part;
a field magnet secured either directly or indirectly to the shaft, magnetic poles thereof being arranged in a circumferential direction;
a second cover section formed by press work from a metal plate, the first cover section being secured thereto, having a concave part in which the recessed part of the first cover section and the armature are accommodated; and
a seal member for sealing a space defined between the first cover section and the second cover section by intervening therebetween at a part where both sections contact, wherein:
a rotating body comprises the shaft and the field magnet; and
a stator assembly comprises the first cover section, the armature, the second cover section and the seal member.

2. The motor as claimed in claim 1, wherein the armature contacts an inner-side surface of the second cover section.

3. The motor as claimed in claim 2, wherein an outer-side surface of the armature is pressed into the inner-side surface of the second cover section.

4. The motor as claimed in claim 1, wherein a circuit board on which an electronic part for generating a drive current supplied to the armature is mounted is provided between a bottom of the concave part of the second cover section and a bottom of the recessed part of the first cover section.

5. The motor as claimed in claim 4, further comprising a busbar contacting the circuit board and thereby secured, the busbar further being electrically connected to the circuit board and the armature so as to lead the drive current to the armature, wherein the busbar abuts the bottom of the concave part of the second cover section.

6. The motor as claimed in claim 5, wherein the armature comprises:
a core formed in such a manner that a plurality of thin magnetic plates is multi-layered;
a coil formed in such a manner that an electric lead is wound around the core; and
two or more insulators covered the core and the electric lead wound over the insulators so as to insulate the core and the coil from each other, wherein:
the busbar abuts the bottom of the second cover section on an opposite side of the first cover section; and
the insulator abuts the circuit board or the busbar so that a position of the armature along the central axis is determined.

7. The motor as claimed in claim 2, wherein:
the inner-side surface of the second cover section has a step part protruding inward; and
the armature abuts the step part of the second cover section so that a position of the armature along the central axis is determined.

8. An electrically-driven motor comprising:
a first cover section, being watertight, including a recessed part having a cylindrical shape closed at one end thereof, and a flange extending toward a radially outward direction from a rim of an opening of the recessed part;
an armature having plural teeth arranged around the recessed part of the first cover section, each tip of the teeth directing toward a radially inward direction;
a shaft extending along the central axis of the recessed part of the first cover section, an one end thereof accommodated in the recessed part;
a field magnet secured either directly or indirectly to the shaft, magnetic poles thereof being arranged in a circumferential direction;
a second cover section secured to the first cover section, having a concave part in which the recessed part of the first cover section and the armature are accommodated;
a seal member for sealing a space defined between the first cover section and the second cover section by intervening therebetween at a part where both sections contact; and
a busbar contacting a circuit board and thereby secured, the busbar further being electrically connected to the circuit board and the armature so as to lead a drive current to the armature, wherein:
an upper surface of the busbar contacts a lower surface of the bottom of the second cover section so that a position thereof along the central axis is determined; and
an upper part of the armature contacts a lower surface of the busbar or a lower surface of the circuit board so that a position thereof along the central axis is determined.

9. The motor as claimed in claim 8, wherein:
the second cover section is formed by press work from a metal plate; and
the armature contacts an inner-side surface of the second cover section.

10. The motor as claimed in claim 8, wherein the armature comprises:
a core formed in such a manner that a plurality of thin magnetic plates is multi-layered along the central axis;
a coil formed in such a manner that an electric lead is wound around the core; and
two or more insulators covered the core and the electric lead wound over the insulators so as to insulate the core and the coil from each other, wherein:
an upper surface of a insulator which covered from upper side abuts a lower surface of the busbar or a lower surface of the circuit board so that a position of the armature along the central axis is determined.

11. A manufacturing process of an electrically-driven motor, as claimed in claim 5, comprising:
a) a step of securing the circuit board to the busbar for supplying a drive current to the armature for electrically connecting thereto;
b) a step of setting the busbar to a predetermined position and orientation relative to the armature, and electrically connecting thereto;
c) a step of inserting a group which includes the circuit board, the busbar and the armature, into the concave of the second cover section through an opening thereof and positioning the group relative to the second cover section by abutting the busbar to the bottom of the concave part thereof; and
d) a step of sealing the space defined by the first cover section and the second cover section, into which the group of the circuit board, the busbar and the armature is already inserted and positioned, by intervening a seal member therebetween.

12. The motor manufacturing process as claimed in claim 11, wherein the armature comprises:
a core formed in such a manner that a plurality of thin magnetic plates is multi-layered along the central axis;
a coil formed in such a manner that an electric lead is wound around the core; and
two or more insulators covered the core and the electric lead wound over the insulators so as to insulate the core and the coil from each other, wherein:
the core of the armature and the second cover section abut each other so that a position of the armature in a radial direction is determined in said step c).

13. The motor manufacturing process as claimed in claim 11, wherein the armature comprises:
a core formed in such a manner that a plurality of thin magnetic plates is multi-layered along the central axis;
a coil formed in such a manner that an electric lead is wound around the core; and
two or more insulators covered the core and the electric lead wound over the insulators so as to insulate the core and the coil from each other, wherein:
an upper surface of a insulator which covered from upper side and a lower surface of the busbar or a lower surface of the circuit board abut each other so that a position of the busbar along the central axis with respect to the armature is determined in said step b).

14. A pump comprising:
a motor as claimed in claim 1;
a first pump casing having a lid at the recessed part;
a second pump casing for forming a pump chamber by abutting the first pump casing;
a bearing for rotatably supporting the rotating body, the bearing being provided in the second pump casing; and
an impeller for forming a path of the liquid by rotating integral with the rotating body when secured to the shaft, the impeller being provided in the pump chamber.

15. A pump comprising:
a motor as claimed in claim 8;
a first pump casing having a lid at the recessed part;
a second pump casing for forming a pump chamber by abutting the first pump casing;
a bearing for rotatably supporting the rotating body, the bearing being provided in the second pump casing; and
an impeller for forming a path of the liquid by rotating integral with the rotating body when secured to the shaft, the impeller being provided in the pump chamber.

16. The pump as claimed in claim 14, wherein the pump is installed in a vehicle.

17. The pump as claimed in claim 15, wherein the pump is installed in a vehicle.
